(19) United States
(12) Patent Application Publication
(10) Pub. No.: US 2004/0169371 A1
(43) Pub. Date: Sep. 2, 2004

(54) Speed lock pipe fitting

(76) Inventor: Howard H. Hagiya, Hitachi-Ohta (JP)

Correspondence Address: PATRICK M. DWYER PC, SUITE 114, 1818 WESTLAKE AVENUE N., SEATTLE, WA, 98109, US

(21) Appl. No.: 10/734,746

(22) Filed: Dec. 11, 2003

Related U.S. Application Data
(60) Provisional application No. 60/432,439, filed on Dec. 11, 2002.
(60) Provisional application No. 60/507,824, filed on Oct. 1, 2003.

(51) Int. Cl. F16L 37/00

(52) U.S. Cl. 285/305; 285/404

(57) ABSTRACT

A novel speed lock fitting with a threaded drive pin that obviates any shock or vibration to the piping system, and can also be used in tight spaces where no one could practically swing a hammer. Assembly of the connecting fitting with drive pins as shown in the illustrations can be accomplished with a cordless electric driver or hand tool such as a wrench or socket wrench. Disassembly is then simply the reverse of assembly. The drive pin can be applied with greater net force to the pipe wall, thus making it a good choice for standard and heavy wall pipe.

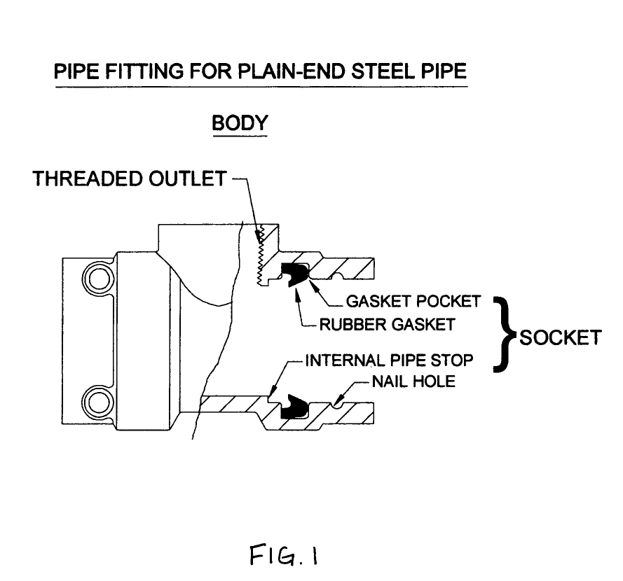

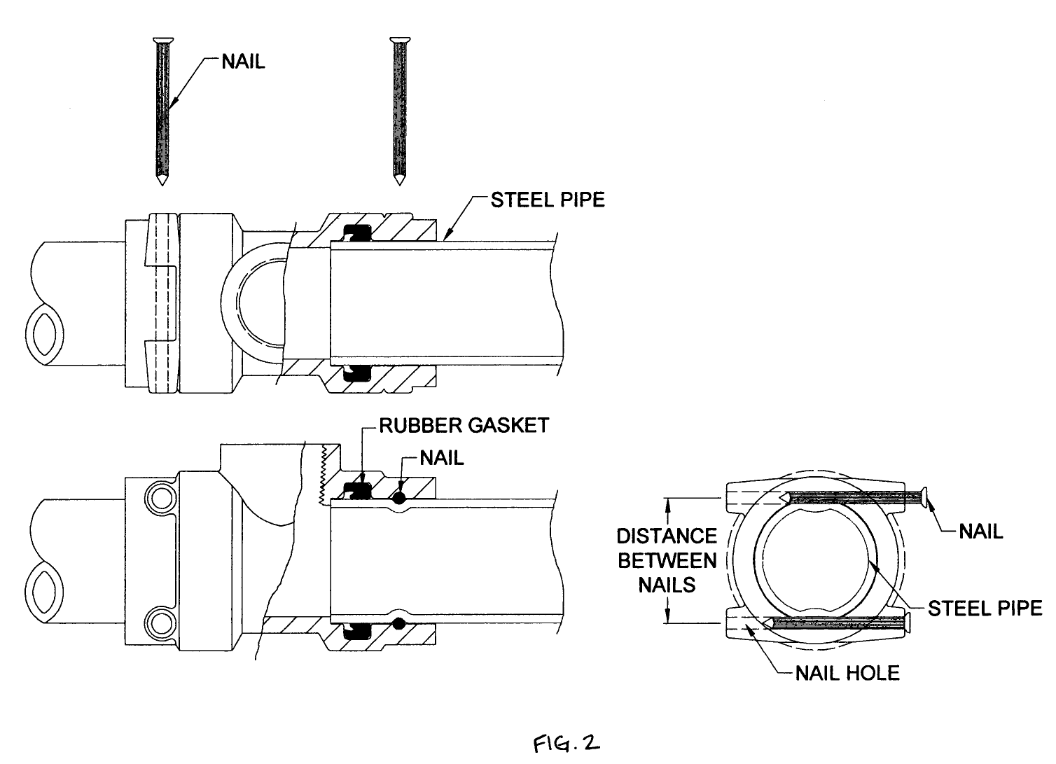

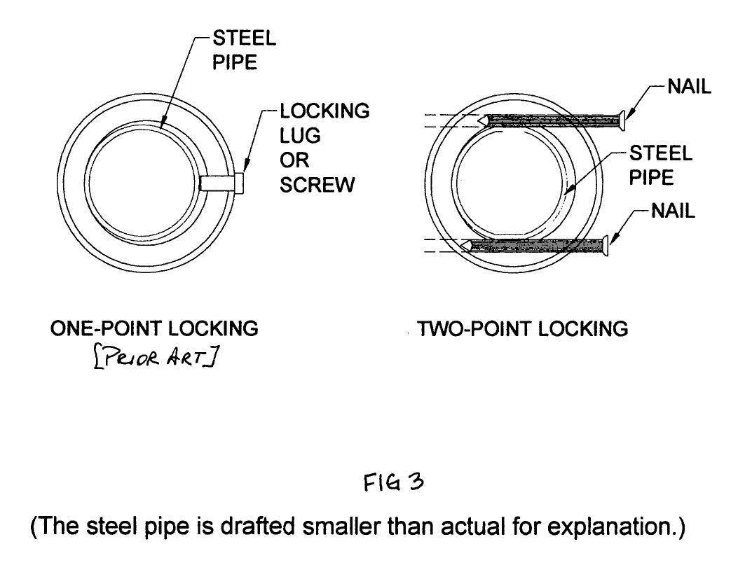

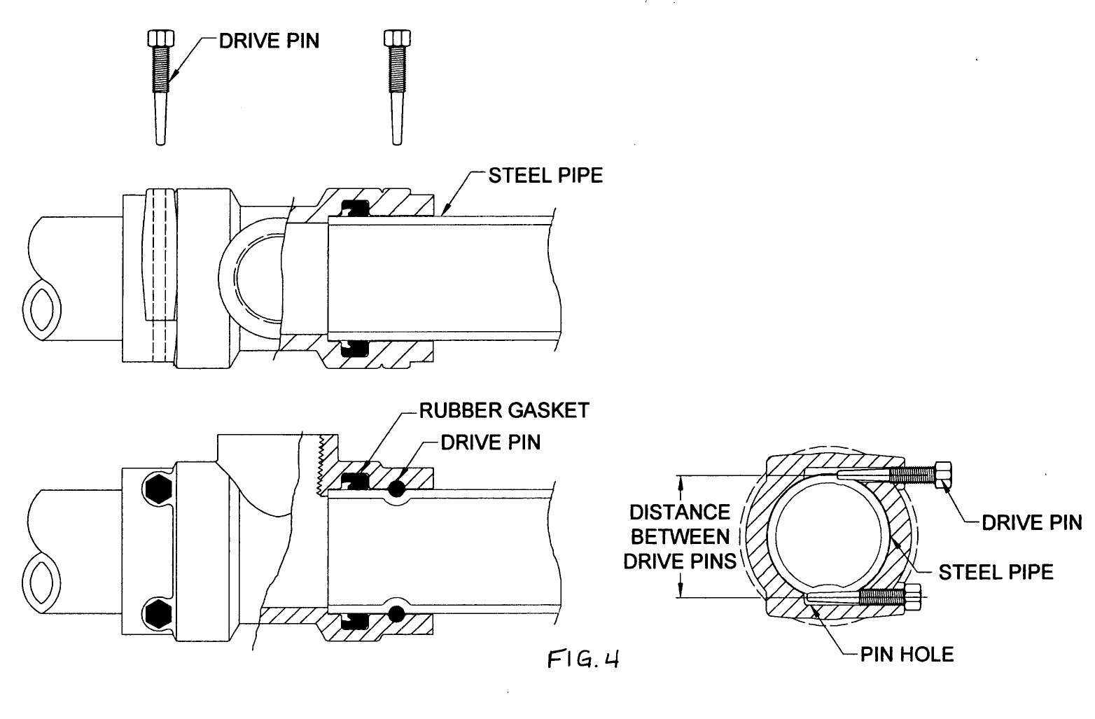

This application claims priority to provisional application No. 60/432,439 filed Dec. 11, 2002 and provisional application No. 60/507,824 filed Oct. 01, 2003

### TECHNICAL FIELD

The invention relates to a speed lock pipe fitting.

### DISCLOSURE OF THE INVENTION

Plain-end pipes may be joined releasably and reliably simply by inserting them into the disclosed fitting and fixing them with hardened steel nails, as shown.

The preferred fitting body is made of ductile iron. The fitting grasps pipe at two points (with the preferred two-nail type), or advantageously with only one nail or screw. The fitting employs a conventional pressure-responsive rubber gasket for sealing. The fitting is advantageously used for thin-wall steel or stainless steel pipe of small diameters up to 2″ size, and for low and moderate working pressure use, for instance up to 300 psi. Advantages:

1. One can use plain-end or beveled-end steel or stainless steel pipe as it is without processing the end to be threaded or grooved.

2. No special pipe end preparation is necessary. No cleaning or polishing is required.

3. All commercial steel or stainless steel pipe up to schedule 40 can be used as they are as long as they are made with their outside diameters within =/−1% tolerances (or other publicly allowed tolerance).

4. No special tool is required except a hammer or sledgehammer.

5. No tape-seal or pipe dope is required.

6. Easy installation. Insert pipes into the fitting and hammer nails to hold pipes in fitting.

7. Easy disassembly. Remove the nails by hammering the tip of the nails from the other end, or using optional double-headed nails.

8. Pipe end separation can be uniformly spaced by a cast-in internal pipe stop.

9. Allows rotation of either or both pipes before locking into fitting.

10. Rigid positioning. No linear movement under pressure.

In the alternative, hardened steel screws can be used instead of hardened steel nails. In this case, the required tool will be a screwdriver, manual type or electric type.

The fitting body is made of iron castings, gray iron, ductile iron or malleable iron with its sockets as cast. Machining required is drilling of nail holes and threading of the threaded-end outlet, when applicable. Fittings may advantageously be 90 degree elbows, 90 degree reducing elbows, 45 degree elbows, straight tees, reducing tees, straight couplings, mechanical tees or any other useful configurations.

Number of nails or screws employed can be two for each end or three or four each end depending on desired service pressures. Guide holes in the fitting can be either plain holes for nails or threaded holes for screws.

Diameter of nails, number of nails and distance between nails are determined depending on the desired service pressure. The larger the diameter of nails and smaller the distance between nails, the higher pressure the fitting can withstand.

Guide holes are all the way through so that nails can be inserted from either end of the guide holes and nails can be removed when necessary by pushing back from the other end

The preferred fitting has a ductile iron body including a number of cylindrical chambers or “sockets” (two sockets in the configuration of a threaded-outlet tee as shown in the drawing) that accommodates plain-end steel pipe, two nail holes and two nails for each socket. The socket consists of a gasket pocket, rubber gasket, internal pipe stop and nail holes. Any threaded-outlet portion of a fitting is the same as regular threaded fittings. The same system can be applied to a variety of other fitting configurations with a combination of socket end(s) and threaded end(s). The only machining required is to drill nail holes and threading when applicable.

A plain-end steel pipe is inserted into a socket of the fitting until it reaches to the internal pipe stop. The rubber gasket is thereby compressed for sealing. Simply insert two steel nails into the nail holes with a hammer to complete the joint. The nails are preferably made of carbon steel, and hardened. The nails exert a lateral pinching or grasping action to hold the pipe with sufficient force from two directions, preferably opposing directions. The distance between nails is selected depending on pipe OD (=outside diameter), nail diameter and desired service pressure.

### BACKGROUND OF EXISTING JOINT PRODUCTS

1. Locking Lug Type (i.e. Victaulic FIT): A specially designed locking lug is installed on each fitting end with hardened steel lug retainer. The locking lug will secure pipe to the fitting with a 90 degree turn. The fitting is made of gray iron and uses a pressure-responsive rubber gasket for sealing. In order to secure a pressure holding fit, each socket of the fitting must be precisely machined. This fitting catches the pipe at one point. Both specially designed locking lugs with steel lug retainers and need for machining push up the production cost.

Max. allowed O.D. is +0.01 inches. (The generally acceptable pipe OD tolerances are (1%, say 2″ pipe, for example, 2.375″ (0.023.)

Pipe end preparation requires cleaning (polishing) with a special pipe cleaning tool (PCT-11).

2″ size FIT uses two lugs for each end of fitting.

2. Locking Screw Type: A specially designed locking screw is used for fixing the pipe instead of the above locking lug. This fitting catches the pipe at one point. The fitting is made of gray iron and uses a pressure responsive rubber gasket for sealing. All others aspects are same as above.

Novel Departure:

Both locking lug type and locking screw type attempt to fix the pipe with a force from one-point (or direction) of the pipe. This requires not only a precise machining of the socket when manufacturing but also cleaning or polishing of the pipe end when installation. If pipe OD is at the larger side of the allowable tolerance, it does not get into the socket. If pipe OD is at the smaller side of the allowable tolerance, the locking force will be badly reduced. With the disclosed Locking Nail Type fitting, these disadvantages are eliminated.

Alternatively, a threaded drive pin is employed instead of or in addition to the disclosed nails or screws above. The threaded drive pin obviates any shock or vibration to the piping system, and can also be used in tight spaces where no one could practically swing a hammer. Assembly of the connecting fitting with drive pins as shown in the illustrations can be accomplished with a cordless electric driver or hand tool such as a wrench or socket wrench. Disassembly is then simply the reverse of assembly. The drive pin can be applied with greater net force to the pipe wall, thus making it a good choice for standard and heavy wall pipe.

A preferred drive pin is illustrated, having a hex head portion, a threaded portion and a tapered portion. In operation, the driver or wrench acts on the head (other driver combinations known in the art will serve as well) to screw the threaded portion into a correspondingly threaded pin hole in the fitting. The tapered portion is drawn up tight against the pipe wall and then, with further threading action, deforms the pipe wall to hold it in the fitting, all as illustrated.

I claim:

1. A speed lock pipe fitting for a pipe comprising a threaded drive pin, the pin having a hex head portion, a threaded portion and a tapered portion, wherein the pin head is adapted for driving with a conventional driver or wrench to screw the threaded portion into a correspondingly threaded pin hole in the fitting, and whereby the tapered portion of the pin is drawn up tight against the pipe wall to deform a wall of the pipe.
